(19) United States
(12) Patent Application Publication
(10) Pub. No.: US 2012/0060980 A1
(43) Pub. Date: Mar. 15, 2012

(54) MARTENSITIC WIRE WITH THIN POLYMER COATING

(75) Inventors: Luc Stefaan Ledoux, Ardooie (BE); Haiqiang Yang, Jiangyin (CN); Naqiao Qi, Jiangyin (CN)

(73) Assignee: NV BEKAERT SA

(21) Appl. No.: 13/319,896

(22) PCT Filed: Apr. 21, 2010
(86) PCT No.: PCT/EP2010/055228

§ 371 Date: Nov. 10, 2011

(30) Foreign Application Priority Data
May 14, 2009 (EP) 09160292.0

(51) Int. Cl. B32B 15/00; C21D 1/00; C21D 6/00; C21D 1/34

(52) U.S. Cl. 148/537; 148/320

(57) ABSTRACT

An elongated steel element (12) with a martensite, tempered martensite, bainite or sorbite structure has a polymer coating (16) with a thickness lower than 20 μm immediately upon the elongated steel element (14). The friction coefficient and corrosion resistance are both improved by the polymer coating at a lower cost.

### TECHNICAL FIELD

The present invention relates to an elongated steel element with a martensite, tempered martensite, bainite or sorbite structure having a polymer coating immediately upon the elongated steel element. It also relates to a method of manufacturing the elongated steel element.

### BACKGROUND ART

It is well known that the friction coefficient of steel wire is very important for further downstream processing such as brush making.

A common way to reduce friction coefficient is by using a lubricant, such as oil. Mostly oiling is applied to the steel wire to improve further downstream processing, thereby also offering additional corrosion resistance. But the presence of oil on wire surface has the disadvantage to create a sticky surface. For example, when oiled steel wires are bundled, it is difficult to separate these oiled bundles into pre-defined smaller bundles. Moreover, oil is contaminating the work area, possibly creating a hazardous situation for the environment, the safety and the health.

It is also well know that corrosion resistance of bare steel is most often not sufficient.

Corrosion means the disintegration of a steel element into its constituent atoms due to chemical reactions. In other words electrons of steel element react with water and oxygen. Weakening of iron due to oxidation of the iron atoms is a well-known example of electrochemical corrosion. It is also commonly known as rusting. This type of damage typically produces oxide(s) and/or salt(s) of the original steel element.

At present controlled corrosion treatments such as chromate-conversion will increase a steel element's corrosion resistance. However, chromate conversion leads to environment pollution and higher investment costs.

Alternatively, a polymer coating may be applied on the steel element with a prior galvanized coating to get high corrosion resistance. The polymer coating can yield colored coating, but galvanizing before polymer coating causes higher cost and high environment pollution for the steel element. An additional line for polymer coating may also add to the costs.

### DISCLOSURE OF INVENTION

It is an object of the present invention to overcome the problem of the prior art.

It is also an object of the present invention to reduce the environment pollution.

It is a further object of the present invention to provide an elongated steel element with low friction and high corrosion resistance.

It is another object of the present invention to provide a method of manufacturing the elongated steel element.

According to the present invention, an elongated steel element with a martensite, tempered martensite, bainite or sorbite structure has a polymer coating immediately upon the elongated steel element, and the polymer coating has a thickness lower than 20 μm.

Martensite, tempered martensite, bainite and sorbite refer to the four forms of steel crystalline structure. Generally martensite and tempered martensite is harder than pearlite, and bainite has better toughness and stability than pearlite, sorbite has better mechanical characters than pearlite. So martensite, tempered martensite, bainite and sorbite are preferred having regard to the various intended applications or uses.

The terms ‘polymer coating immediately upon the elongated steel element’ refer to an elongated steel element which is a bare elongated steel element without any coating before polymer coating. It means that there is no intermediate coating between the polymer coating and the steel core. So that the elongated steel element has a closed polymer coating to give corrosion protection. The polymer coating also leads to a low friction coefficient (both static friction coefficient and dynamic friction coefficient) elongated steel element while still having high corrosion resistance. Furthermore, as will be explained hereinafter, the thin polymer coating directly upon the elongated steel element saves a lot of cost.

U.S. Pat. No. 5,303,498 discloses a fishing line comprising a strand consisting of steel wires and resin. The steel wires are coated with an anticorrosion metal before being bundled to be coated with resin. It further describes that the carbon content of the steel wire is low, between 0.01% and 0.05%.

U.S. Pat. No. 6,951,985 discloses an electrical cable comprising metal wire, an outer stratum, a first layer and a second layer. The outer stratum and the second layer are formed of electrically insulating material. The first layer is formed of superconducting material. The metal wire is at least coated with three layers to get a superconducting electrical cable.

U.S. Pat. No. 5,789,080 discloses a steel wire with low carbon content, less than 0.20%, coated with silane layer. The silane coating provides a good adhesion to the steel wire while the steel wire is used in the rubber product.

All the above three patent have not mentioned the steel element has a polymer coating immediately upon the elongated steel element.

Preferably the elongated steel element has a tempered martensite structure. In other word, the elongated steel element is tempered to receive a high ductility and toughness next to its hardness and strength. The tempered martensite becomes more tough and more ductile after it is tempered.

The thickness of the polymer coating depends on the property requirement of the elongated steel element. The thicker the polymer coating is, the better the corrosion resistance of the elongated steel element is, but also the higher production cost is.

According to the present invention, the thickness of the polymer coating is lower than 20 μm. Preferably the thickness is lower than 15 μm e.g. lower than 10 μm. Most preferably the thickness ranges from 2 to 4 μm. The elongated steel element could get both low friction coefficient and high corrosion resistance with such adapted polymer coating thickness.

According to the present invention, the polymer is homopolymer or copolymer. Preferably the polymer is copolymer. More preferably the copolymer is based on polyethylene and/or polyacrylate or based on polystyrene and/or polyacrylate.

The polymer coating is giving an improved friction coefficient and corrosion resistance to the elongated steel element. Compared with prior oiling coated steel element, the friction coefficient is nearly 20% lower and corrosion resistance is nearly 50% higher. It benefits further downstream processing such as brush making or control cable wire making. Especially the dynamic friction coefficient is improved to protect the surface of the coating from being damaged while the further downstream processing like bundling and cutting.

Furthermore, a polymer coating can reduce the environment pollution as compared with oiling.

A coloring pigment also can be added into the polymer. Either inorganic or organic pigment can be used. Also the pigment can be special pigment such as luminescent pigment.

Thus the elongated steel element can be applied the whole visible spectrum, from violet to red.

According to the present invention, the carbon content of the elongated steel element ranges from 0.30 wt % to 1.00 wt % (wt % is the percentage by weight). Preferably the carbon content of the elongated steel element ranges from 0.50 wt % to 0.80 wt %. More preferably the carbon content of the elongated steel element is 0.60 wt %.

The steel composition may also comprise manganese content ranging from 0.30% to 1.50%, a silicon content ranging from 0.10% to 1.80%, a maximum sulphur content of 0.035%, a maximum phosphorus content of 0.035% and a maximum chromium content of 1.50%. Minor amounts of copper, vanadium, boron, nickel, molybdenum, niobium, copper calcium, aluminum, titanium and nitrogen may be present.

The elongated steel element can be round wire, profile wire, strip, sheet, blade or other elongated steel element. And the profile wire can be a flat wire, a rectangular wire, a square wire or other profile wire.

For round steel wires, the diameter ranges from 0.15 mm to 20 mm. Preferably the diameter ranges from 0.20 mm to 0.80 mm.

A method of manufacturing the polymer coated steel element, comprises following steps:
(a) austenitizing a elongated steel element;
(b) rapid cooling said elongated steel element, to have a martensite, bainite or sorbite structure;
(c) immersing said elongated steel element in a bath with a polymer to provide a polymer coating of lower than 20 μm to said elongated steel element.

As is known in the art, to get a very pure martensite structure, the elongated steel element should be rapidly cooled. But the elongated steel element will be damaged if cooling is too fast.

To get a pure bainite structure, the elongated steel element must be heated once again to the austenite region (austenizing) and cooled somewhat more slowly to a controlled temperature before being fully quenched (cooled) to a low temperature.

To make martensite or sorbite tough and ductile, the elongated steel element can be tempered after rapid cooling. The elongated steel element is tempered with a temperature ranging from 300° C. to 450° C. following the step (b) mentioned above.

To the elongated steel element, there is a balance between strength and ductility. To get required mechanical properties, precise control of time and temperature during the tempering process is needed.

The polymer coating may be formed with the heat energy still present inside the wire during tempering. To save energy cost, the elongated steel element can be cooled till its temperature is between 100° C. and 250° C. after having rapid cooling or tempering. Then the high temperature elongated steel element goes through an immersion bath to be coated with polymer, thereby using the remanent energy within the elongated element. This technique has the advantage that the polymer coating can be done in line with the tempering step without adding energy. A separate polymer coating line, such as an extrusion line, is no longer required.

Additionally the elongated steel element can be coated with wax after the polymer coating. The wax coating can protect the polymer coating against being damaged while further downstream processing. Furthermore the friction coefficient of the steel element is improved. It is nearly 40% lower than the polymer coated elongated steel element. Also the corrosion resistance is better than the elongated steel element coated with the polymer coating alone.

The thickness of the wax coating is less than 10 μm. Preferably the thickness is less than 5 μm.

According to the present invention, the elongated steel element with low friction coefficient and high corrosion resistance can be used in many applications, such as brush wire, flexible card wire, control cable wire and in wiper arms and wiper blades for windows. It also can be applied with colors to meet market product requirement such as for example identification purposes.

### BRIEF DESCRIPTION OF FIGURES IN THE DRAWINGS

FIG. 1 shows a cross-section of a round steel wire with a polymer coating;

FIG. 2 shows a cross-section of a round steel wire with a polymer coating and a wax coating;

FIG. 3 shows a cross-section of a flat steel wire with a polymer coating and a wax coating.

### MODE(S) FOR CARRYING OUT THE INVENTION

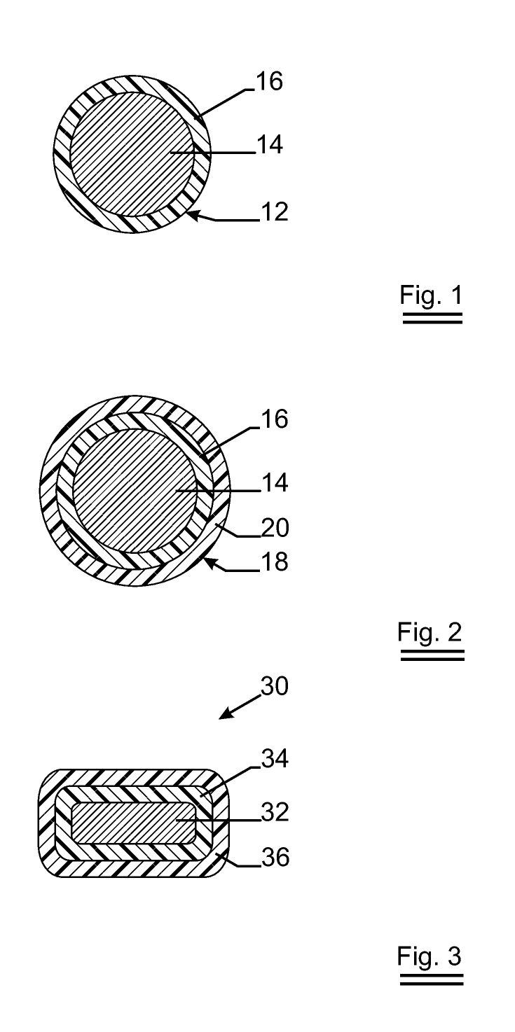

A first embodiment is shown in FIG. 1. The round steel wire 12 with a carbon content of 0.6% and a diameter of 0.80 mm has a steel core 14 and polymer coating 16. The thickness of polymer coating 16 is 3 μm.

To manufacture the polymer coated round steel wire 12, the starting product is a wire rod which is first cold drawn in a number of subsequent drawing steps until its final (steel) diameter. Thereafter, the steel core 14 firstly is austenitized with a temperature from 860° C. to 1000° C., and then rapid cooled till the temperature is lower than 60° C., then tempered with a temperature of 300° C. to 450° C., then cooled till the temperature is between 150° C. to 200° C. to get a tempered martensite structure. Then, instead of waiting until the tempered steel wire cools down until the temperature of the environment, the tempered steel wire 14 is immersed into the polymer bath with a polymer concentration of 30 vol % and a temperature lower than 70° C. to get a 3 μm polymer coating. The heat present in the steel wire 14 helps to form the polymer coating on the steel wire.

A second embodiment is shown in FIG. 2. The round steel wire 18 has two coating layers, first the polymer coating 16 and the second wax coating 20. The polymer coated steel wire 12 is immersed into wax bath in line with polymer coating. The thickness of wax coating is 3 μm.

Compared with prior oiling coated steel wire, some tests results are summarized in the following table.

| | | | Corrosion resistance | |
|---|---|---|---|---|
| | | | (reaching 5% dark | |
| | Static | Dynamic | rust) | |
| | friction | friction | salt spray | humidity chamber |
| | coefficient | coefficient | red rust | red rust |
| the first | 0.170 | 0.159 | 3 h | 30 h |
| embodiment | | | | |
| the second | 0.101 | 0.099 | 3.3 h | 32 h |
| embodiment | | | | |
| prior oiling | 0.201 | 0.199 | 2 h | 22 h |
| coated steel wire | | | | |

According to the above table, both the steel wire 18 with polymer and wax coating and the steel wire 12 with polymer coating have the better properties than the prior oiling coated steel wire. Even a very thin polymer coating (3 μm) and a very thin wax coating offer a corrosion resistance which is about 50% or more higher than the corrosion resistance of an oiled steel wire.

Referring to FIG. 3, a third embodiment is a flat steel wire 30 with bainite structure having a steel core 32, a 10 μm polymer coating 34 and a 7 μm wax coating 36.

A fourth embodiment is a steel blade with martensite structure having 15 μm polymer coating and 6 μm wax coating.

The coated martensitic steel wire according to the invention may be advantageously used as brush wire. The thin polymer coating prevents the steel wires from sticking in a bundle and yet provides sufficient corrosion resistance as required for the intended use of brush wire.

A polymer coated martensitic steel wire may also be used as wire in a control cable, e.g. a push-pull cable.

Alternatively, a polymer coated round tempered martensitic steel wire according to the invention may be used as strength element in a wiper arm of a window wiper.

A polymer coated flat or rectangular martensitic steel wire according to the invention may be used in wiper blades of a window wiper.

1. An elongated steel element with a martensite, tempered martensite, bainite or sorbite structure, said steel element having a polymer coating immediately upon said elongated steel element, said polymer coating having a thickness lower than 20 μm.

2. An elongated steel element as claimed in claim 1, characterized in that said elongated steel element has a tempered martensite structure.

3. An elongated steel element as claimed in claim 1, characterized in that said polymer coating has a thickness lower than 15 μm.

4. An elongated steel element as claimed in claim 1, characterized in that said polymer coating has a thickness ranging from 2 to 4 μm.

5. An elongated steel element as claimed in claim 1, characterized in that said polymer is a copolymer.

6. An elongated steel element as claimed in claim 5, characterized in that said copolymer is based on polyethylene and/or polyacrylate.

7. An elongated steel element as claimed in claim 1, characterized in that the carbon content of said elongated steel element ranges from 0.30 wt % to 1.00 wt %.

8. An elongated steel element as claimed in claim 1, characterized in that said elongated steel element is a round steel wire.

9. An elongated steel element as claimed in claim 8, characterized in that the diameter of said round steel wire ranges from 0.15 mm to 20 mm.

10. An elongated steel element as claimed in claim 1, characterized in that said elongated steel element is a profile steel wire.

11. An elongated steel element as claimed in claim 1, characterized in that said elongated steel element is a flat steel wire.

12. An elongated steel element as claimed in claim 1, characterized in that said elongated steel element is a steel blade.

13. An elongated steel element as claimed in claim 1, characterized in that said elongated steel element is additionally coated with wax on top of the polymer coating.

14. A method of manufacturing a coated elongated steel element, said method comprising the following steps:
(a) austenitizing an elongated steel element;
(b) rapid cooling said elongated steel element to have a martensite, bainite or sorbite structure;
(c) immersing said elongated steel element in a bath with a polymer to provide a polymer coating of lower than 20 μm to said elongated steel element.

15. A method as claimed in claim 14, characterized in that said elongated steel element is further tempered with a temperature ranging from 300° C. to 450° C. following the step (b).

16. An elongated steel element as claimed in claim 2, characterized in that said polymer coating has a thickness lower than 15 μm.
